(19) United States
(12) Patent Application Publication
(10) Pub. No.: US 2016/0364220 A1
(43) Pub. Date: Dec. 15, 2016

(54) METHOD FOR OPTIMIZING LOOP PROCESSING UNDER CONSTRAINT ON PROCESSORS TO BE USED

(71) Applicant: FUJITSU LIMITED, Kawasaki-shi (JP)

(72) Inventor: Masaki ARAI, Kawasaki (JP)

(73) Assignee: FUJITSU LIMITED, Kawasaki-shi (JP)

(21) Appl. No.: 15/151,611

(22) Filed: May 11, 2016

(30) Foreign Application Priority Data
Jun. 11, 2015 (JP) 2015-118002

(51) Int. Cl. G06F 9/45

(52) U.S. Cl. CPC G06F 8/443; G06F 8/49

(57) ABSTRACT

Based on a description of loop processing in a source code, for each of count values each indicating a number of times the loop processing has been iterated, instructions of one loop portion corresponding to the each count value and a dependence relationship between a pair of instructions having a data dependence are displayed. Upon receiving an input to specify that an instruction group including instructions having no dependences on each other is executed by an identical processor, usage efficiency of a cache memory, an alignment degree of used data, and a number of threads at a time of parallel execution are calculated and displayed. Upon receiving an input to determine the instruction group, the source code is compiled, and loop optimization using a polyhedral model under constraints in which the instruction group is executed by the identical processor is performed on the loop processing.

### CROSS-REFERENCE TO RELATED APPLICATION

This application is based upon and claims the benefit of priority of the prior Japanese Patent Application No. 2015-118002, filed on Jun. 11, 2015, the entire contents of which are incorporated herein by reference.

### FIELD

The embodiments discussed herein are related to a method for optimizing loop processing under constraint on processors to be used.

### BACKGROUND

A program that a computer is to be caused to execute is created, for example, by using a high-level language, and is transformed into a computer-executable format by compiling the program with a compiler. In the compiler, conversion from a source code to a machine language is performed and optimization processing is executed so that the execution time and a memory usage amount are minimized.

As one of pieces of optimization processing by a compiler, there exists a loop optimization method using a polyhedral model. In such a method, for loop processing, a relationship between an instruction to generate data and an instruction to use the data is represented by a constraint equation, and a program that satisfies a number of constraint equations is generated. The constraint equation is a system of equalities or a system of inequalities in the optimization process.

As a technology related to the loop optimization, for example, there is a technology that seeks a solution to an optimization problem of obtaining a series of elements as direct products of binary finite fields. In addition, there is a technology by which overall optimization is accomplished through cooperation between elements whose evaluation functions are convex functions. In addition, there is a technology that allows a user to precisely control optimization by a compiler. In addition, there is a technology that allows a system parameter used for an information processing system to be optimized with high precision at high speed.

Japanese Laid-open Patent Publication No. 2011-150465, International Publication Pamphlet No. WO2012/160978, Japanese Laid-open Patent Publication No. 2006-114069, and Japanese Laid-open Patent Publication No. 2013-89025 are related art.

A. V. Aho, R. Sethi, J. D. Ullman, and M. S. Lam, “Compilers: Principles, Techniques, and Tools, Second Edition”, PEARSON Addison-Wesley, 2006 is also a related arts.

### SUMMARY

According to an aspect of the invention, based on a description of loop processing in a source code, for each of count values each indicating a number of times the loop processing has been iterated, instructions of one loop portion corresponding to the each count value are displayed by arranging the instructions in predetermined order, and a dependence relationship between a pair of instructions having a data dependence is displayed. Upon receiving an input to specify that an instruction group including instructions having no dependences on each other is executed by an identical processor, usage efficiency of a cache memory, an alignment degree of used data, and a number of threads at a time of parallel execution are calculated and displayed. Upon receiving an input to determine the instruction group, the source code is compiled, and loop optimization using a polyhedral model under a constraint in which the instruction group is executed by the identical processor is performed on the loop processing.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of a computer, according to an embodiment;

FIG. 2 is a diagram illustrating an example of a hardware configuration of a computer, according to an embodiment;

FIG. 3 is a diagram illustrating an example of a compile function of a computer, according to an embodiment;

FIG. 4 is a diagram illustrating an example of a procedure of optimization of loop processing, according to an embodiment;

FIG. 5 is a diagram illustrating an example of screen display for optimization support, according to an embodiment;

FIG. 6 is a diagram illustrating an example of an operational flowchart for optimization support processing, according to an embodiment;

FIG. 7 is a diagram illustrating an example of an operational flowchart for validity evaluation processing, according to an embodiment;

FIG. 8 is a diagram illustrating an example of a program including loop processing, according to an embodiment;

FIG. 9 is a diagram illustrating an example of a graph representing an iteration space, according to an embodiment;

FIG. 10 is a diagram illustrating an example of a graph after group selection has been performed, according to an embodiment;

FIG. 11 is a diagram illustrating an example of error display for grouping, according to an embodiment;

FIG. 12 is a diagram illustrating an example of error display for grouping, according to an embodiment;

FIG. 13 is a diagram illustrating an example of a program in which loop processing is optimized, according to an embodiment;

FIG. 14 is a diagram illustrating an example of a program including loop processing, according to an embodiment;

FIG. 15 is a diagram illustrating an example of a graph of a data dependency when a plurality of loop variables exists, according to an embodiment;

FIG. 16 is a diagram illustrating an example of an iteration space of loop processing, according to an embodiment;

FIG. 17 is a diagram illustrating an example of an iteration space of loop processing, according to an embodiment;

FIG. 18 is a diagram illustrating an example of selection of grouped instances, according to an embodiment; and

FIG. 19 is a diagram illustrating an example of selection of grouped instances, according to an embodiment.

### DESCRIPTION OF EMBODIMENTS

In the loop optimization method using the polyhedral model by the compiler, at the time of loop optimization, solutions of a number of constraint equations (systems of equalities or systems of inequalities in the optimization process) are calculated. Typically, there is a plurality of solutions for the system of equalities or the system of inequalities. The processing efficiency of the program is changed depending on a solution selected by the compiler from among the plurality of solutions. For example, the compiler selects a single appropriate solution by using heuristics inside the compiler and executing various pieces of estimation calculation.

However, the quality of the processing efficiency of a program to be generated depends on various factors such as an execution environment of the generated program. Therefore, a solution that has been selected by a certain method may not be the best solution at all times. Typically, a compiler does not include information determined at the time of execution of the program, for example, pieces of information on memory usage status, data alignment, and the like. Therefore, it is difficult to cause the compiler to automatically select an optimal solution depending on various factors such as the usage environment of the program, from among a plurality of solutions each of which satisfies a constraint equation for loop optimization.

It is desirable to select an appropriate solution from among a plurality of solutions each of which satisfies a constraint equation of loop optimization.

Embodiments are described below with reference to drawings. All or some of the embodiments may be implemented so as to be combined in consistent range.

### First Embodiment

In a first embodiment, at the time of loop optimization using a polyhedral model, a solution on which the intention of a user has been reflected is allowed to be selected from a plurality of solutions each of which satisfies a constraint of optimization, and loop optimization based on the selected solution is performed. The loop optimization using the appropriate solution from among the plurality of solutions may be performed by reflecting the intention of the user on the solution.

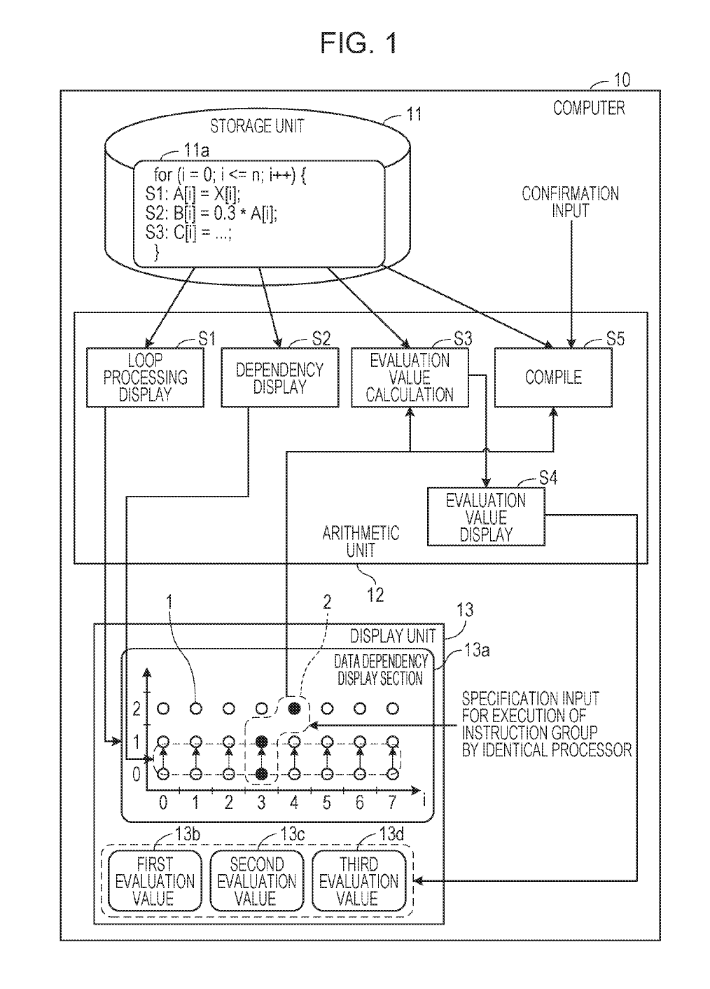

FIG. 1 is a diagram illustrating a configuration example of a computer according to the first embodiment. A computer 10 includes a storage unit 11, an arithmetic unit 12, and a display unit 13.

The storage unit 11 stores a source code 11a. The source code 11a is described, for example, using a high-level language, and includes loop processing.

The arithmetic unit 12 compiles the source code 11a, and generates an execution program using a machine language. The arithmetic unit 12 optimizes the loop processing at the time of compiling of the source code 11a. The loop processing is optimized, for example, using the polyhedral model.

In addition, the arithmetic unit 12 allows the user to easily select an appropriate solution from a plurality of solutions each of which satisfies a constraint for the optimization, at the time of loop optimization using the polyhedral model. That is, the arithmetic unit 12 executes the following processing at the time of compiling of the source code 11a.

First, the arithmetic unit 12 arrays instructions 1 having one loop portion corresponding to a loop-count value indicating the number of times of iteration processing, and causes a data dependency display section 13a of the display unit 13 to display the instructions 1, for each of the loop-count values, based on a description of the loop processing included in the source code 11a (Step S1). For example, the arithmetic unit 12 sets a loop-count value of the iteration processing to the horizontal axis, and sets objects (circles in FIG. 1) indicating the instructions 1 of one loop portion for the corresponding loop-count value, to the vertical axis.

Next, the arithmetic unit 12 analyzes the source code 11a, causes the data dependency display section 13a of the display unit 13 to display a dependency between two instructions having data dependency (Step S2). For example, when data that has been generated by one of the two instructions is referred to in the other instruction, there is a dependency between the two instructions. For example, the arithmetic unit 12 displays a line that connects objects respectively corresponding to the two instructions having a data dependency. The line may be an arrow starting from an instruction to generate data and pointing to an instruction that refers to the data.

Next, when the arithmetic unit 12 receives a specification input to specify execution of an instruction group 2 including a plurality of instructions not having a dependency by an identical processor, the arithmetic unit 12 calculates evaluation values related to the efficiency of the processing in a case in which the instruction group 2 is executed by the identical processor (Step S3). The evaluation value includes, for example, a first evaluation value 13b indicating a usage efficiency of a cache memory, a second evaluation value 13c indicating an alignment degree of used data, and a third evaluation value 13d indicating the number of threads at the time of parallel execution, in the case in which the instruction group 2 is executed by the identical processor. For example, the second evaluation value 13c has a larger value as data array used for the processing in which the instruction group is executed by an identical processor is processed more easily by a single instruction multiple data (SIMD) instruction. After the evaluation values have been calculated, the arithmetic unit 12 causes the data dependency display section 13a of the display unit 13 to display the calculated first evaluation value 13b, second evaluation value 13c, and third evaluation value 13d (Step S4).

In addition, when the arithmetic unit 12 receives a determination input to determine the instruction group 2, the arithmetic unit 12 compiles the source code 11a by performing optimization of the loop processing using the polyhedral model under a constraint in which the instruction group 2 is executed by the identical processor (Step S5). That is, the arithmetic unit 12 calculates a solution that satisfies a constraint obtained by adding the constraint in which the instruction group 2 is executed by the identical processor to the constraint in the optimization of the loop processing using the polyhedral model. The arithmetic unit 12 performs the loop optimization by sorting instructions of the loop processing depending on the calculated solution. In addition, the arithmetic unit 12 transforms the sorted instructions into a machine language to obtain a program with an execution format.

As described above, an appropriate solution may be selected from a plurality of solutions each of which satisfies the condition of the loop optimization. That is, at the time of compiling of the source code 11a, the loop optimization is performed so as to satisfy a constraint in accordance with the specification input of the instruction group 2 by the user. This means that the user may cause the arithmetic unit 12 to select a certain solution from the plurality of solutions each of which satisfies the condition of the loop optimization by specifying instructions to be included in the instruction group 2.

In addition, since evaluation values corresponding to the specified instruction group 2 are displayed, the user may easily recognize the appropriateness of the selection of the instruction group 2. In a case in which the obtained evaluation values satisfy the request of the user, reception of the determination input from the user allows the arithmetic unit 12 to optimize the loop processing and to generate a program with an execution format so that the constraint in which the instruction group 2 being specified at that time is executable by the identical processor is satisfied. The generated program is a program that allows the loop processing to be executed efficiently, and a solution of the loop optimization that has been applied to the generation of such a program is an appropriate solution from among the plurality of solutions.

The arithmetic unit 12 evaluates the validity of the specification input, depending on whether the specified instruction group 2 is executable by the identical processor, in response to the specification input of the instruction group 2, and may display the evaluation result on the display unit 13. As a result, an error in the specification input of the instruction group 2 may be notified to the user, and execution of compile by the instruction group 2 having an incorrect configuration is avoided.

In addition, in the evaluation of the validity, there is a case in which not all of the instructions in the instruction group 2 are allowed to be executed by an identical processor, but a plurality of instructions constituting a subset in the instruction group 2 may be executed by the identical processor. In this case, the arithmetic unit 12 may identify an instruction that is not included in the subset from among the instruction group 2, and performs error display for the identified instruction. As a result, when there is an error in the specified instruction group 2, the user may easily grasp a part of the specified instruction group, which has an error.

In addition, even when not all of the instructions in the specified instruction group 2 are allowed to be executed by an identical processor, but the plurality of instructions constituting the subset in the instruction group 2 is allowed to be executed by the identical processor, the arithmetic unit 12 may perform the loop optimization. In this case, for example, the arithmetic unit 12 performs, for the loop processing, the loop optimization using the polyhedral model under a constraint in which the plurality of instructions constituting the subset is executed by the identical processor. As a result, even when the user does not correctly imagine the result of the loop optimization, the loop optimization is allowed to be performed with a content close to the request of the user.

The arithmetic unit 12 is, for example, a processor included in the computer 10. In addition, the storage unit 11 is, for example, a memory or a storage device included in the computer 10.

### Second Embodiment

A second embodiment is described below. In the second embodiment, when loop optimization using a polyhedral model is performed by a compiler, an intention of the user is reflected on the loop optimization by using a graphical user interface (GUI).

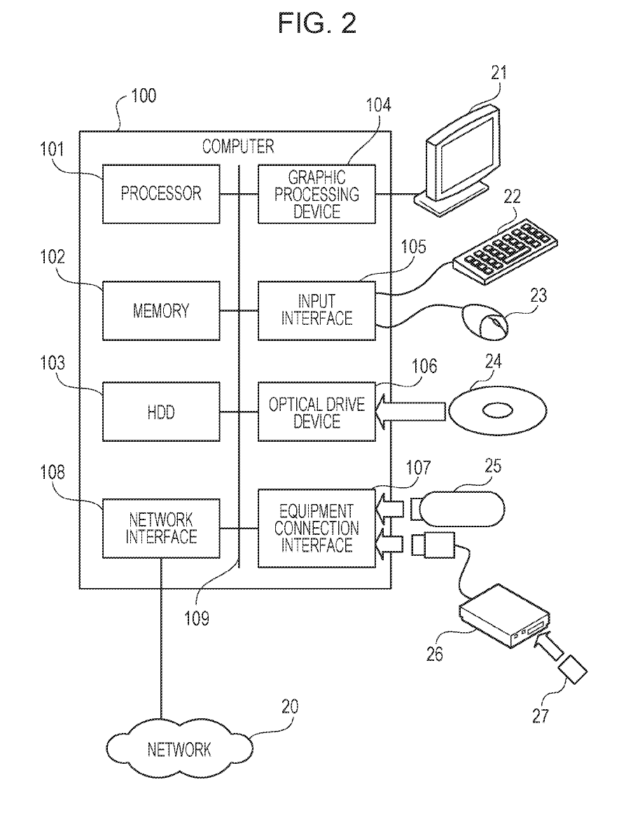

FIG. 2 is a diagram illustrating a configuration example of hardware of a computer according to the second embodiment. A computer 100 is controlled by a processor 101 as a whole. A memory 102 and a plurality of pieces of peripheral equipment are coupled to the processor 101 through a bus 109. The processor 101 may be a multiprocessor. The processor 101 is, for example, a central processing unit (CPU), a micro processing unit (MPU), or a digital signal processor (DSP). At least some of functions achieved by causing the processor 101 to execute a program may be achieved by an electronic circuit, such as an application specific integrated circuit (ASIC) or a programmable logic device (PLD).

The memory 102 is used as a main memory of the computer 100. The memory 102 temporarily stores at least some of a program of an operating system (OS) and an application program that the processor 101 is caused to execute. In addition, the memory 102 stores various pieces of data used for processing by the processor 101. As the memory 102, for example, a volatile semiconductor memory device, such as a random access memory (RAM), is used.

As the peripheral equipment coupled to the bus 109, there are a hard disk drive (HDD) 103, a graphic processing device 104, an input interface 105, an optical drive device 106, an equipment connection interface 107, and a network interface 108.

The HDD 103 magnetically performs writing and reading of data for a built-in disk. The HDD 103 is used as an auxiliary storage device of the computer 100. The HDD 103 stores the program of the OS, the application program, and various pieces of data. As the auxiliary storage device, a non-volatile semiconductor memory device (solid state drive (SSD)), such as a flash memory, may be used.

A monitor 21 is coupled to the graphic processing device 104. The graphic processing device 104 causes an image to be displayed on a screen of the monitor 21 in response to an instruction from the processor 101. As the monitor 21, there are a display unit using a cathode ray tube (CRT), a liquid crystal display unit, and the like.

A keyboard 22 and a mouse 23 are coupled to the input interface 105. The input interface 105 transmits a signal that has been transmitted through the keyboard 22 and the mouse 23, to the processor 101. The mouse 23 is an example of a pointing device, and other pointing devices may also be used. As the other pointing devices, there are a touch-screen, a tablet, a touch pad, a trackball, and the like.

The optical drive device 106 performs reading of data recorded to an optical disk 24, by using laser light or the like. The optical disk 24 is a portable recording medium to which data has been recorded so that the data is allowed to be read by reflection of light. As the optical disk 24, there are a digital versatile disc (DVD), a DVD-RAM, a compact disc read only memory (CD-ROM), a CD-recordable (R)/rewritable (RW), and the like.

The equipment connection interface 107 is a communication interface used to couple peripheral equipment to the computer 100. For example, a memory device 25 and a memory reader/writer 26 may be coupled to the equipment connection interface 107. The memory device 25 is a recording medium on which a communication function with the equipment connection interface 107 is mounted. The memory reader/writer 26 is a device that performs writing of data to a memory card 27 or reading of data from the memory card 27. The memory card 27 is a card-type recording medium.

The network interface 108 is coupled to a network 20. The network interface 108 transmits and receives data to and from other further computers or communication devices through the network 20.

By the above-described hardware configuration, the processing functions according to the second embodiment may be achieved. The computer 10 according to the first embodiment may also be implemented by hardware similar to the computer 100 illustrated in FIG. 2.

The computer 100 achieves the processing functions according to the second embodiment, for example, by executing a program recorded to a computer-readable storage medium. A program in which a processing content that the computer 100 is caused to execute has been described may be recorded to various recording mediums. For example, the program that the computer 100 is caused to execute may be stored in the HDD 103. The processor 101 loads at least some of programs in the HDD 103 to the memory 102, and executes the programs. In addition, the program that the computer 100 is caused to execute may be recorded to the portable recording medium, such as the optical disk 24, the memory device 25, or the memory card 27. The program stored in the portable recording medium is installed in the HDD 103 and is allowed to be executed, for example, by control from the processor 101. In addition, the processor 101 may read a program from the portable recording medium directly and execute the program.

At the time of compiling of a program in such a computer 100, optimization of loop processing using a polyhedral model is performed.

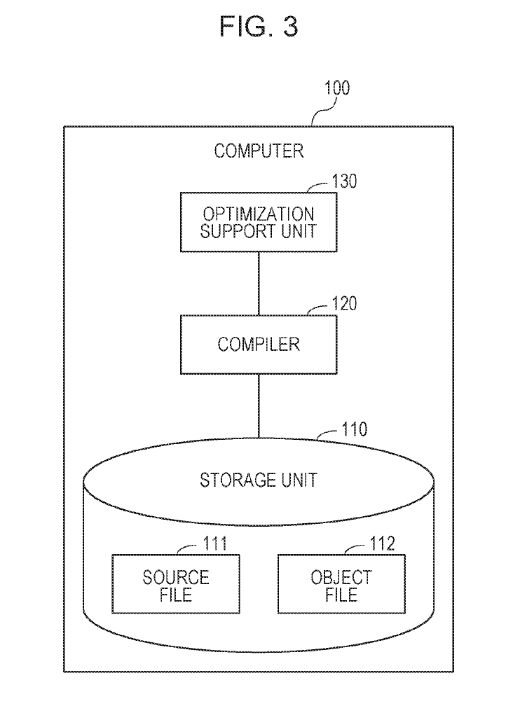

FIG. 3 is a block diagram illustrating a compile function of the computer. The computer 100 includes a storage unit 110, a compiler 120, and an optimization support unit 130.

The storage unit 110 stores a source file 111 and an object file 112. For example, a program is described in the source file 111 by using a high-level language such as a C language. A program using a machine language is described in the object file 112.

The compiler 120 compiles the source file 111 in the storage unit 110 to generate the object file 112. The compiler 120 performs the optimization of the loop processing using the polyhedral model at the time of compiling of the source file 111.

The optimization support unit 130 supports the optimization of the loop processing by the compiler 120, based on an operation from the user through the GUI. For example, the optimization support unit 130 groups instances, in response to an input, through an input device such as the mouse, on an interactive optimization control screen. The instance is an instruction whose value of a variable has been identified. For example, the user performs input so that instances to be executed by an identical processor are caused to be included in an identical group.

In addition, the optimization support unit 130 may also evaluate the validity of the grouping that has been specified by the user. When there is an error in the groping as a result of the validity evaluation, the optimization support unit 130 may display the error. In addition, the optimization support unit 130 may calculate evaluation values by various evaluation indexes for the grouping that has been specified by the user and display the evaluation values.

Lines that connect the elements illustrated in FIG. 3 indicate some of communication paths, and a communication path other than the illustrated communication paths may be set. In addition, the function of each of the elements illustrated in FIG. 3 may be achieved, for example, by causing a computer to execute a program module corresponding to the element.

The optimization of the loop processing using the polyhedral model is described below in detail. In the loop optimization method using the polyhedral model, “extraction of parallelism without synchronization” and “extraction of parallelism with synchronization” are performed.

<Extraction of Parallelism without Synchronization>

In the extraction of parallelism without synchronization, for example, affine space partition using information on an internal data structure used for a convex polyhedron analysis path is utilized. In addition, a constraint condition related to the parallelism without synchronization is created. The creation processing of the constraint condition is described below.

First, for all pairs of statements S and T having data dependency, a constraint set indicating accesses to an identical array component is created. It is assumed that an access of the statement S is (X, F_{S}), and an access of the statement T is (Y, F_{T}), where “X” and “Y” respectively indicate the array names, and “F_{S}” and “F_{T}” respectively indicate the matrices for array accesses. When these two accesses to an identical array component are performed, the following formula is satisfied.

$$X = Y ⋀ {F}_{S} ( \begin{matrix}\vec{{i}_{S}} \\ \vec{{i}_{gv}} \\ 1\end{matrix} ) = {F}_{T} ( \begin{matrix}\vec{{i}_{T}} \\ \vec{{i}_{gv}} \\ 1\end{matrix} ) \qquad ( 1 )$$

Here, “ [symbol] ” means conjunction (logical AND). The vector i_{S} and the vector i_{T} are respectively vectors of loop variables of the statements S and T. The vector i_{gv} is a vector of a global parameter variable. At that time, when either of (X, F_{S}) and (Y, F_{T}) or both of (X, F_{S}) and (Y, F_{T}) are write instructions, it is probable that data dependency occurs. When such a condition is represented, the following formula is obtained.

$$( {F}_{T}^{′} - {F}_{S}^{′} ) ( \begin{matrix}\vec{{i}_{S}} \\ \vec{{i}_{T}} \\ \vec{{i}_{gv}} \\ 1\end{matrix} ) = \vec{0} \qquad ( 2 )$$

Here, “F′_{S}” and “F′T” are matrices obtained by respectively extending “F_{S}” and “F_{T}” so as to correspond to the dimension of the vectors (vector i_{S}, vector i_{T}, and vector i_{gv}, and 1)^{T}. When such an equation is solved by using Gaussian elimination, typically, the following solution is obtained.

$$( \begin{matrix}\vec{{i}_{S}} \\ \vec{{i}_{T}} \\ \vec{{i}_{gv}} \\ 1\end{matrix} ) = U ( \begin{matrix}\vec{t} \\ 1\end{matrix} ) \qquad ( 3 )$$

Here, “U” is a matrix of a rational constant. In addition, “t” is a vector of a free variable. Assignment of the instance of the statement S to a processor p_{S} (processor identifier) is represented as follows.

$${p}_{s} = {C}_{s} ( \begin{matrix}\vec{{i}_{S}} \\ \vec{{i}_{gv}} \\ 1\end{matrix} ) \qquad ( 4 )$$

In addition, assignment of the instance of the statement T to a processor p_{T} is represented as follows.

$${p}_{T} = {C}_{T} ( \begin{matrix}\vec{{i}_{T}} \\ \vec{{i}_{gv}} \\ 1\end{matrix} ) \qquad ( 5 )$$

As a result, a condition p_{S}=p_{T} in which the statements S and T are executed by an identical processor is obtained as follows.

$${C}_{S} ( \begin{matrix}\vec{{i}_{S}} \\ \vec{{i}_{gv}} \\ 1\end{matrix} ) = {C}_{T} ( \begin{matrix}\vec{{i}_{T}} \\ \vec{{i}_{gv}} \\ 1\end{matrix} ) \qquad ( 6 )$$

Here, “C_{S}” and “C_{T}” are respectively vectors of schedule variables of the statements S and T. When the condition of the formula (6) is rewritten, the following formula is obtained.

$$( {C}_{T}^{′} - {C}_{S}^{′} ) ( \begin{matrix}\vec{{i}_{S}} \\ \vec{{i}_{T}} \\ \vec{{i}_{gv}} \\ 1\end{matrix} ) = \vec{0} \qquad ( 7 )$$

Here, “C′_{S}” and “C_{T}” are obtained by respectively extending vectors “C_{S}” and “C_{T}” so as to correspond to the dimension of the vectors (vector i_{S}, vector i_{T}, and vector i_{gv}, and 1)^{T}. The affine space partition corresponds to optimization in which execution of instances of statements having data dependency is assigned to an identical processor. Such a constraint condition may be represented as the following formula (8) obtained by combining the formula (3) and the formula (7).

$$( {C}_{T}^{′} - {C}_{S}^{′} ) U ( \begin{matrix}\vec{t} \\ 1\end{matrix} ) = \vec{0} \qquad ( 8 )$$

A constraint related to the vectors C_{T} and C′_{S} is to be obtained here, so that the vector t of the free variable may be ignored. Thus, the following constraint is created.

(C′_{T}−C′_{S})U=\vec{0} (9)

The following constraint is created by combining constraints each having the format of the formula (9), which have been created from combinations of a set of all statements having data dependency and all of the accesses.

$$E ( \begin{matrix}\vec{c} \\ 1\end{matrix} ) = \vec{0} \qquad ( 10 )$$

Here, the vector c is a vector including schedule variables of all of the statements, and “E” is a constant matrix.

The value of the variable vector may be calculated by solving the formula (10) as a simultaneous integer equation.

<Extraction of Parallelism with Synchronization>

In the extraction of parallelism with synchronization, for example, affine time partition using information on an internal data structure used for a convex polyhedron analysis path is utilized. In addition, a constraint condition related to the parallelism with synchronization is created. The creation processing of the constraint condition is described as follows.

A creation procedure of the constraint condition in the extraction of parallelism with synchronization is equivalent to the affine space partition in the extraction of parallelism without synchronization until the creation of the formula (3). The execution time t₅ of the instance of the statement S is set as follows.

$${t}_{S} = {C}_{S} ( \begin{matrix}\vec{{i}_{S}} \\ \vec{{i}_{gv}} \\ 1\end{matrix} ) \qquad ( 11 )$$

In addition, the execution time t_{T} of the instance of the statement T is set as follows.

$${t}_{T} = {C}_{T} ( \begin{matrix}\vec{{i}_{T}} \\ \vec{{i}_{gv}} \\ 1\end{matrix} ) \qquad ( 12 )$$

As a result, a condition “t_{S}≦t_{T}” in which the statement T is executed after the statement S is represented as follows.

$${C}_{S} ( \begin{matrix}\vec{{i}_{S}} \\ \vec{{i}_{gv}} \\ 1\end{matrix} ) \leq {C}_{T} ( \begin{matrix}\vec{{i}_{T}} \\ \vec{{i}_{gv}} \\ 1\end{matrix} ) \qquad ( 13 )$$

Here, “C_{S}” and “C_{T}” are respectively vectors of schedule variables of the statements S and T.

When the condition of the formula (13) is rewritten, the following formula is obtained.

$$( {C}_{T}^{′} - {C}_{S}^{′} ) ( \begin{matrix}\vec{{i}_{S}} \\ \vec{{i}_{T}} \\ \vec{{i}_{gv}} \\ 1\end{matrix} ) \geq \vec{0} \qquad ( 14 )$$

Here, “C′_{S}” and “C_{T}” are matrices obtained by respectively extending matrices “C_{S}” and “C_{T}” so as to correspond to the dimension of the vectors (vector i_{S}, vector i_{T}, and vector i_{gv}, and 1)^{T}. An inequality constraint may be created for the vector of the schedule variable of each of the statements by using a constraint condition related to a loop iteration space for the vector of each of the loop variables and Farkas lemma. The following constraint is created by combining constraints each having the format of the inequality, which have been created from combinations of a set of all statements having data dependency and all of the accesses.

$$E ( \begin{matrix}\vec{c} \\ 1\end{matrix} ) \geq 0 \qquad ( 15 )$$

Here, the vector c is a vector including schedule variables of all of the statements, and “E” is a constant matrix.

The value of the variable vector may be calculated by solving the formula (15) as an integer linear constraint problem.

In the above-described procedure, a specific value of the vector c of the schedule variable when the affine time partition is applied to each of the statements S may be obtained.

The optimization such as pipelining of the loop processing may be performed based on the solutions of the constraint problems that have been generated in the above-described “extraction of parallelism without synchronization” and “extraction of parallelism with synchronization”. However, there are the following problems in the loop optimization.

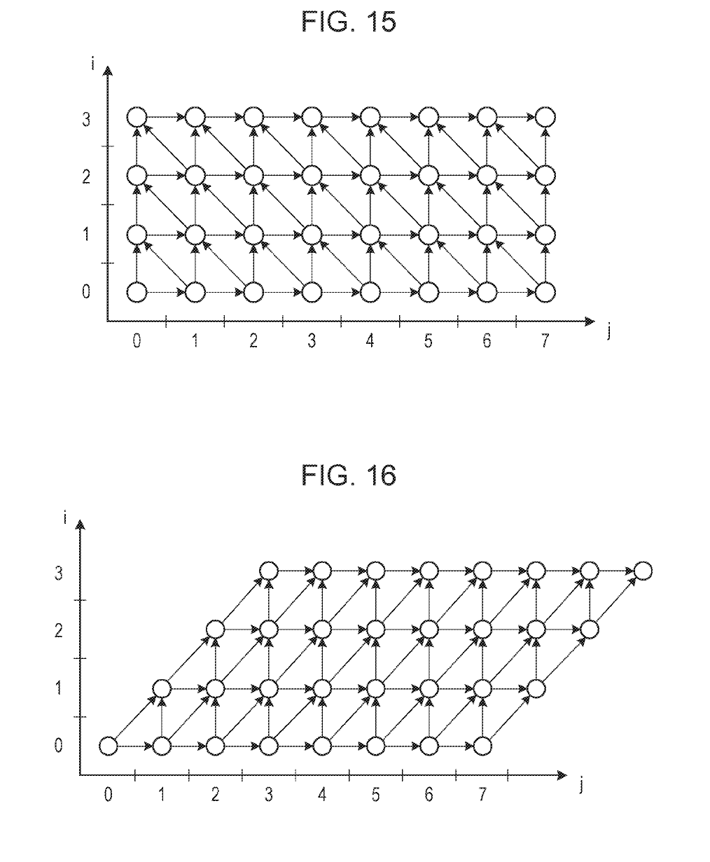

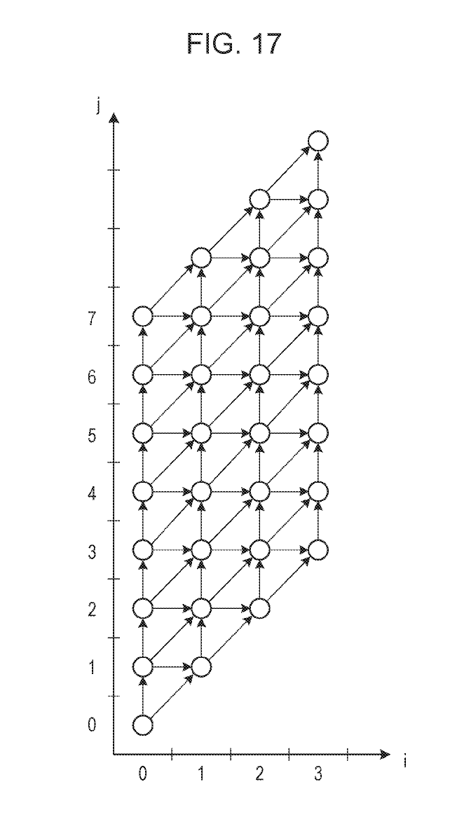

In the loop optimization method using the polyhedral model by the compiler 120, the formula (10) that is a system of equalities or the formula (15) that is a system of inequalities is solved in the optimization process. At that time, typically, there are solutions for each of the formulas, and there are no specific criteria for the compiler 120 to select an appropriate solution. In the example of the affine time partition, whether a program including the iteration space illustrated in FIG. 15 becomes the iteration space illustrated in FIG. 16 or the iteration space illustrated in FIG. 17 is determined depending on a selection method of a solution (the details of FIGS. 15, 16, and 17 are described later). In such a problem, the compiler 120 selects a single solution by using heuristics inside the compiler 120 and performing various pieces of estimation calculation. However, whether the optimization is appropriate depends on various factors such as a state in which an optimized program is executed, so that the compiler 120 may not select the best solution even using a certain criterion that has been defined in advance.

In addition, even when there are options of a plurality of solutions, the selection of a solution is performed as an integer linear constraint problem inside the compiler 120. Therefore, there is a problem that a programmer using the compiler 120 is not allowed to control the selection of a solution.

In addition, typically, the compiler 120 does not include pieces of information determined at the time of execution of the program, for example, pieces of information on memory usage status and data alignment. There is a case in which these pieces of information are important for performance improvement, but it is difficult to combine these pieces of information and the optimization method using the polyhedral model by means of only the compiler 120.

Here, in the second embodiment, the optimization support unit 130 is provided, and the operation is performed so that the optimization support unit 130 and the compiler 120 cooperate. The compiler 120 achieves appropriate optimization of the loop processing in the program that is the compile target by using the optimization support unit 130.

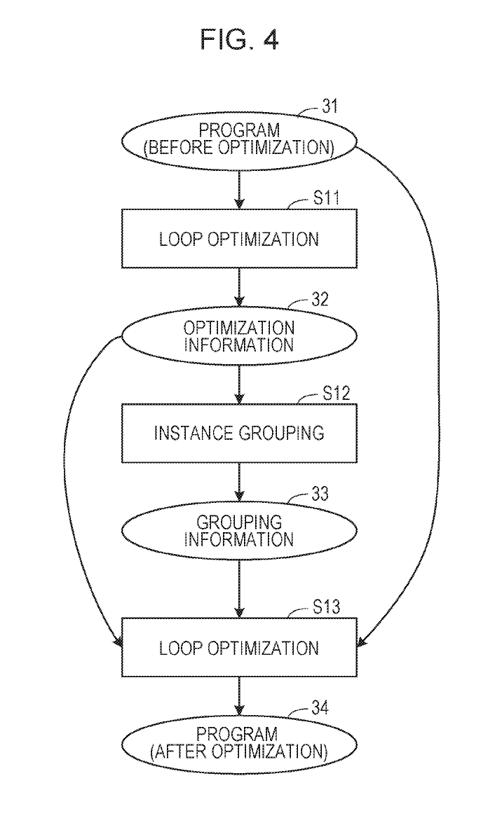

FIG. 4 is a diagram illustrating a procedure of optimization of loop processing. First, the user inputs a program 31 before the optimization (source code) to the compiler 120, and instructs the compiler 120 to create optimization information 32 used when loop optimization using the polyhedral model is performed on the program 31. The compiler 120 performs the loop optimization using the polyhedral model on the program 31 (Step S11). The compiler 120 generates the optimization information 32 at the time of loop optimization. The optimization information 32 includes a constraint equation on the loop optimization (system of equalities or system of inequalities) and information used to display a data dependency graph. The compiler 120 transmits the generated optimization information 32 to the optimization support unit 130.

The user performs interactive input on the optimization support unit 130, and groups instances of instructions included in the loop processing, based on the optimization information 32 (Step S12). For example, the optimization support unit 130 displays, on the monitor 21, data dependency and an iteration space of a loop on the program 31, and supports the loop optimization using the polyhedral model in response to the input from the user. For example, the optimization support unit 130 outputs grouping information 33 indicating a group of the instances that have been specified by the user, to the compiler 120. The grouping information 33 includes, for example, information indicating a statement in the program 31 corresponding to each of the grouped instances and coordinate information on the iteration space of the loop.

The compiler 120 obtains the original program 31, the optimization information 32, and the grouping information 33 that has been output from the optimization support unit 130, and performs loop optimization using the information that has been specified by the user (Step S13). For example, the loop optimization is performed under a constraint in which the instances belonging to the group indicated by the grouping information 33 are executed by an identical processor. Then, the optimized program 34 is output.

As described above, the loop optimization is performed on which the grouping information 33 output from the optimization support unit 130 has been reflected. In addition, the optimization support unit 130 may perform grouping, in response to a specification input from the user through the GUI, so that the loop optimization on which the intention of the user has been reflected is performed.

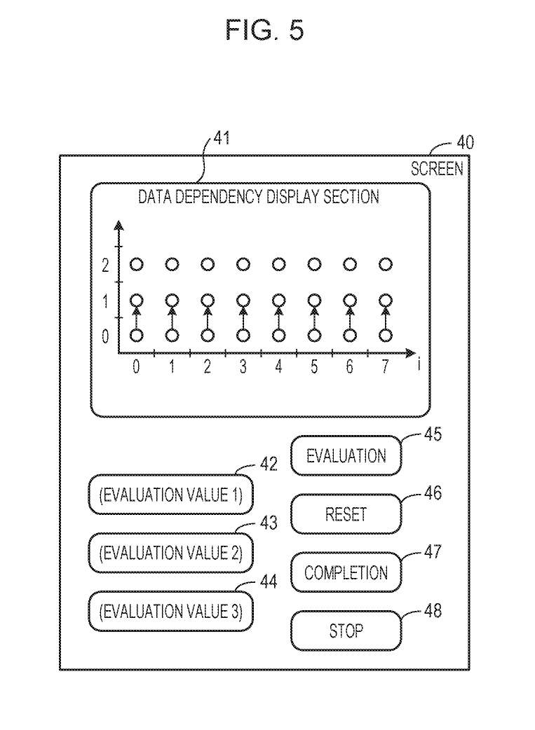

FIG. 5 is a diagram illustrating an example of an optimization support screen display. A screen 40 displayed by the optimization support unit 130 includes a data dependency display section 41, a plurality of evaluation value display sections 42 to 44, an evaluation button 45, a reset button 46, a completion button 47, and a stop button 48.

The data dependency display section 41 is an area on which a graph indicating the presence or absence of a data dependency between instances of instruction statements is displayed. In the data dependency display section 41, an iteration space of a loop and data dependency between the instances are represented by the graph. For example, on the data dependency display section 41, the graph is displayed in which the horizontal axis indicates the number of times of iteration (i) of the loop processing, and the vertical axis indicates instances of instruction statements in each of the pieces of loop processing. In the example of FIG. 5, the instances of the instruction statements are represented by white circles. In addition, data dependencies between the instances are represented by arrows each of which connects the instances. The user may specify instances to be included in an identical group, for example, by selecting the instances displayed on the data dependency display section 41 (the circles in the data dependency display section 41).

Evaluation values when a grouping result of the instances is evaluated by certain evaluation indexes are respectively displayed on the plurality of evaluation value display sections 42 to 44. The evaluation indexes are, for example, the improvement degree of cache usage efficiency, the promotion degree of SIMD, and the increase degree of the number of threads by parallel execution.

The evaluation button 45 is a button to determine whether the grouping of the instances in the data dependency display section 41 satisfies a constraint condition. When the evaluation button 45 is pressed, the optimization support unit 130 evaluates whether execution of the grouped instances by an identical processor core satisfies the constraint condition. When the constraint condition is not satisfied, an instance that is a cause of the nonconformity is displayed so as to be emphasized on the data dependency display section 41.

The reset button 46 is a button used to reselect instances to be grouped. When the reset button 46 is pressed, the optimization support unit 130 releases the selection state of the instances that are currently being selected.

The completion button 47 is a button used to determine the grouping. When the completion button 47 is pressed, the grouping of the instances that are currently being selected is determined, and output of the grouping information 33 is performed by the optimization support unit 130.

The stop button 48 is a button used to cancel the grouping of the instances. When the stop button 48 is pressed, the optimization support unit 130 closes the screen 40 without grouping the instances.

The user may cause the compiler 120 to perform appropriate loop optimization by performing the operation through the screen 40 illustrated in FIG. 5. The optimization support unit 130 executes the optimization support processing in response to an input through the screen 40.

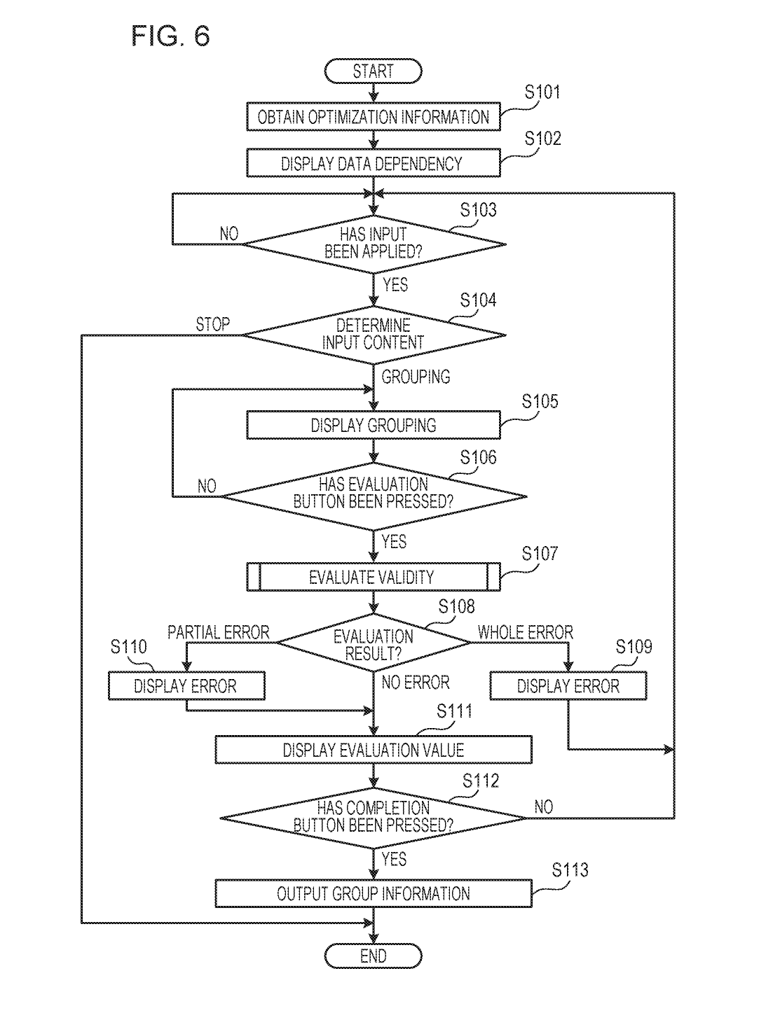

FIG. 6 is a flowchart illustrating an example of a procedure of the optimization support processing.

The optimization support unit 130 obtains the optimization information 32 from the compiler 120 (Step S101).

The optimization support unit 130 displays data dependency and an iteration space of a loop of an optimization target by using a graph, based on the input optimization information 32 (Step S102). For example, the graph is displayed on the data dependency display section 41 illustrated in FIG. 5.

The optimization support unit 130 waits for an input from the user (Step S103). That is, when the optimization support unit 130 receives an input from the user, the processing proceeds Step S104, and when there is no input from the user, the optimization support unit 130 waits for an input from the user by repeating the processing of Step S103.

The optimization support unit 130 determines the input content (Step S104). For example, there are two operations through the input from the user at that time.

One of the operations is an operation to group instances. For example, the user specifies a plurality of instances displayed on the data dependency display section 41, through the input device such as the mouse. The optimization support unit 130 recognizes the specified plurality of instances as instances to be grouped.

The other operation is an operation to stop the grouping. The user presses the stop button 48 to stop the grouping.

When the operation to group the instances has been performed, the processing proceeds to Step S105. When the operation to stop the grouping has been performed, the optimization support processing ends without generation of the grouping information 33.

Each time instances to be grouped are specified in the data dependency display section 41 by the user, the optimization support unit 130 visually displays the instances belonging to an identical group (Step S105). For example, the optimization support unit 130 displays the grouped instances with a color different from the other instances.

The optimization support unit 130 determines whether the evaluation button 45 has been pressed (Step S106). When the evaluation button 45 has been pressed, the processing proceeds to Step S107. When the evaluation button 45 is not pressed, the processing proceeds to Step S105, and acceptance of the grouping of the specified instances and display of the group including the specified instances are continued.

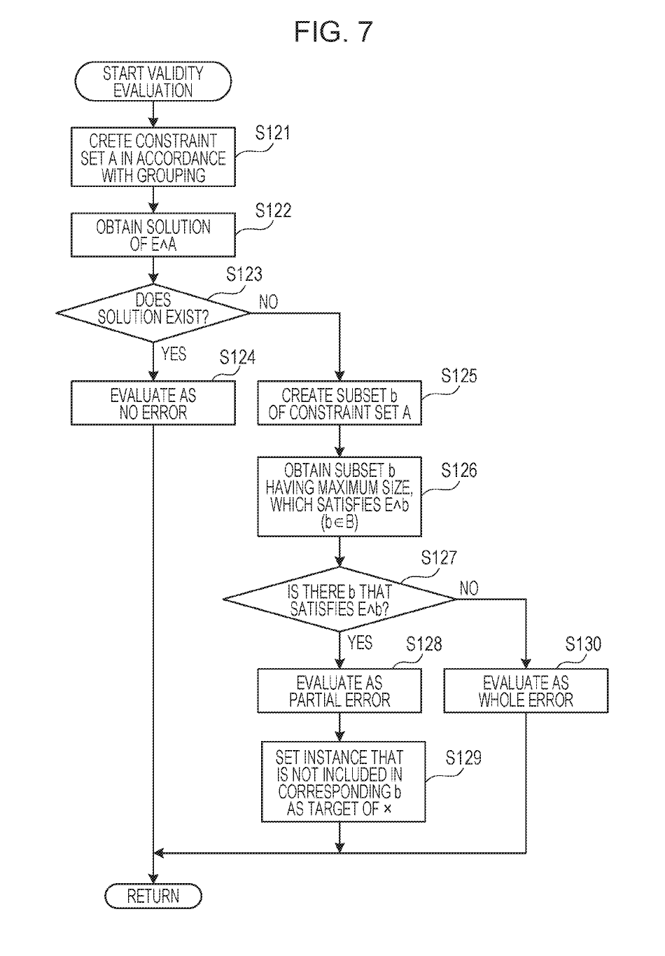

When the grouping has been completed and the evaluation button 45 has been pressed, the optimization support unit 130 evaluates the validity of the grouping that has been selected by the user (Step S107). The validity evaluation processing is described later in detail (see FIG. 7).

The optimization support unit 130 branches the processing depending on the evaluation result of the validity (Step S108). There are the following three types of results for the validity evaluation.

The first evaluation result is an evaluation result indicating that there is no error in the grouping that has been selected by the user. When such an evaluation result has been obtained, the processing proceeds to Step S111. The second evaluation result is an evaluation result indicating that there is an error in a part of the grouping that has been selected by the user. When such an evaluation result has been obtained, the processing proceeds to Step S110. The third evaluation result is an evaluation result indicating that there is an error in the whole grouping that has been selected by the user. When such an evaluation result has been obtained, the processing proceeds to Step S109.

When there is an error in the whole grouping, the optimization support unit 130 performs error display for the whole grouping of the instances (Step S109), and the processing proceeds to Step S103.

When there is an error in a part of the grouping, the optimization support unit 130 performs error display for an instance that is a cause of the error (Step S110), and the processing proceeds to Step S111. That is, when there is an error merely in the part of the grouping, the flow proceeds to processing similar to the processing in the case in which there is no error in the grouping by ignoring selection of the instance that is the cause of the error.

When there is no error or when there is an error in the part of the grouping, the optimization support unit 130 calculates evaluation values of the evaluation indexes for the result of the grouping, and displays the evaluation values (Step S111).

The optimization support unit 130 determines whether the completion button 47 has been pressed (Step S112). When the completion button 47 has been pressed, the processing proceeds to Step S113. When not the completion button 47 but the reset button 46 has been pressed, the processing proceeds to Step S103.

The optimization support unit 130 creates the grouping information 33, and outputs the grouping information 33 to the compiler 120 (Step S113). As a result, the compile processing continues.

As described above, the grouping information 33 in accordance with an input from the user is created by the optimization support unit 130.

The validity evaluation processing of grouping is described later in detail.

FIG. 7 is a diagram illustrating an example of a procedure of the validity evaluation processing.

The optimization support unit 130 creates an additional constraint set A indicating grouping that has been specified by the user, from a constraint set E included in the optimization information 32 and the grouping information 33 (Step S121).

The optimization support unit 130 obtains a solution that satisfies logical “AND” (EAA) of the constraint set E before the grouping and the created additional constraint set A (Step S122).

The optimization support unit 130 determines whether the solution exists in Step S122 (Step S123). When the solution exists in Step S122, the processing proceeds to Step S124. When the solution does not exist in Step S122, the processing proceeds to Step S125.

When the solution exists in Step S122, the optimization support unit 130 determines that the validity evaluation result corresponds to “no error” (Step S124), and the processing ends.

When the solution does not exist in Step S122, the optimization support unit 130 creates all subsets b that are allowed to be generated from the constraint set A (Step S125). Here, a set of the subsets b is referred to as a set B (bεB).

The optimization support unit 130 obtains a subset b having the maximum size, which satisfies a condition in which the solution exists in logical “AND” of the constraint set E and the subset b (Step S126).

The optimization support unit 130 determines whether at least one subset b exists that satisfies the condition in which the solution exists in the logical “AND” of the constraint set E and the subset b (Step S127). When the corresponding subset b exists, the processing proceeds to Step S128. When the corresponding subset b does not exist, the processing proceeds to Step S130.

The optimization support unit 130 determines that the validity evaluation result corresponds to “partial error” (Step S128).

The optimization support unit 130 determines that, out of the instances included in the constraint set A, an instance that is not included in the subset b having maximum size, which has been obtained in Step S126, is a cause of the error (Step S129). The error display (for example, assignment of “x” mark) is performed on the instance that has been determined to be the cause of the error, by the processing of Step S110. After that, the validity evaluation processing ends.

The optimization support unit 130 determines that the validity evaluation result corresponds to “whole error” (Step S130). In this case, the error display is performed on all of the instances that have been selected in the grouping by the processing of Step S109. After that, the validity evaluation processing ends.

The constraint set E is described below. The constraint set E generated by the compiler has the following format.

E\vec{c}Δ0 (16)

Here, “A” corresponds to “=” (in a case of a system of equalities) or “≧” (in a case of a system of inequalities). Here, “E” is an integer matrix, and the vector c is a vector of a variable to be obtained by the compiler. In addition, for a statement S in a loop of the optimization target, the following schedule formula exists.

\vec{C_{S}}\vec{i_{S}} (17)

Here, the vector c_{S} is a vector constituted by a variable included in the vector c, and the vector i_{S} is a variable vector representing an iteration space of the statement S. Each component in the coordinate information G including information on the grouped points indicates a statement of the corresponding point and the specific coordinates of the point. For example, the coordinate information of the statement S is represented as follows.

\vec{i_{S}}=\vec{g} (18)

Here, the vector g is an integer vector indicating location information. From such component information, the following additional constraint is obtained.

\vec{c_{S}}\vec{g}Δt_{G} (19)

Here, “t_{G}” is a parameter variable indicating that the whole group is executed at an identical time. For all of the points in the coordinate information G, an additional constraint set A may be created. Each of the components of the constraint set A is a constraint with the following format.

\vec{c_{S}}\vec{g}Δt_{G} (20)

Instead of the original problem, a solution of optimization of a loop corresponding to the grouping that has been specified in the optimization support unit 130 by the application programmer may be selected by solving the following formula that has been obtained by combining the additional constraint set A and the original problem.

E\vec{c}Δ0 [symbol] A (21)

As described above, loop optimization using an appropriate solution, which fails to be selected by the compiler alone, may be achieved. In addition, optimization that is difficult to be specified by a text-based tool may be instructed using a GUI. In addition, even when an input from the user through the GUI is not accurate, a possibility of the optimization may be expanded by selecting an executable solution that is close to the request of the user.

A certain example of loop optimization in the second embodiment is described below.

<Loop Optimization Example 1>

For convenience of explanation, a program including simple loop processing is assumed here.

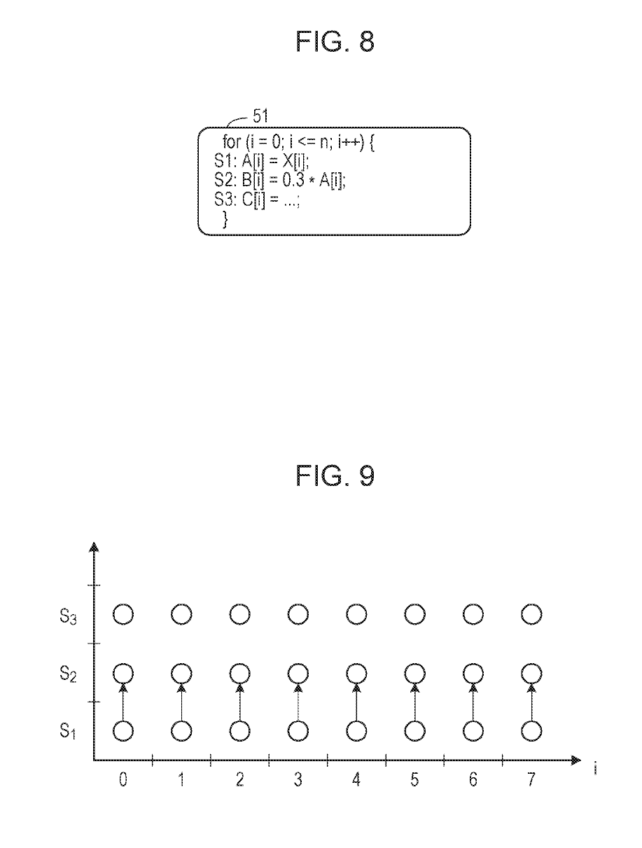

FIG. 8 is a diagram illustrating a first example of a program including loop processing. When a program 51 is optimized, a graph representing an iteration space, which is displayed on the data dependency display section 41 by the optimization support unit 130 for the program 51, is as illustrated in FIG. 9.

FIG. 9 is a diagram illustrating an example of a graph representing an iteration space. In FIG. 9, a circle indicates a single instance of a statement in an iteration space of a loop. An arrow indicates the existence of a data dependency between instances of the statements. The direction of the arrow corresponds to a constraint in which each of the instances is to be executed in order indicated by the arrow.

A procedure to generate the display illustrated in FIG. 9 from the program 51 illustrated in FIG. 8 is as follows. In the program 51 illustrated in FIG. 8, the number of iterations of a loop is a variable n. For the variable, an appropriate numeric value that has been obtained by considering the size of the display, for example, “n=7” is defined. When a loop of the program of FIG. 8 is executed by using “n=7”, it is assumed that eight instances that have been obtained by changing the variable i in the range of 0 to 7 are generated from each of the statements S₁, S₂, and S₃ (referred to as S1, S2, and S3 in the program 51). For example, for the statement S₁, eight instances of (S₁, 0), (S₁, 1), (S₁, 2), (S₁, 3), (S₁, 4), (S₁, 5), (S₁, 6), and (S₁, 7) are generated. The circles of instances corresponding to the statement S1 of FIG. 9 may be displayed by displaying the instances, as the circles, on a plane in which the vertical axis corresponds to the statement S₁ and the horizontal axis corresponds to the number of “i”. Similarly, the circles of the instances corresponding to each of the statements S₂ and S₃ may be also displayed.

A dependency between instances of statements occurs when the instances of the statement access an identical array component, and one of the accesses or both of the accesses correspond to “write”. For example, in the program 51 illustrated in FIG. 8, the instance (S₁, 0) of the statement performs writing to a component A[0] of an array A. In addition, the instance (S₂, 0) of the statement performs reading of the component A[0] of the array A. Thus, a dependency from the instance (S₁, 0) to the instance (S₂, 0) of the statements exists. Since the dependency from the instance (S₁, 0) to the instance (S₂, 0) of the statements exists, the arrow is drawn from the circle corresponding to the instance (S₁, 0) to the circle corresponding to the instance (S₂, 0) of FIG. 5. For the drawn circles of all of the instances of the statements, a graph of FIG. 9 may be generated by inspecting whether a dependency exists and drawing the arrow when the dependency exists.

Based on the program 51 illustrated in FIG. 8, a constraint equation calculated by the compiler 120 when optimization is performed in which parallelism without synchronization is extracted is as follows.

C₁=C₂ [symbol] c₁=c₂ (22)

Here, variables C₁, C₂, and C₃ are variables of the following schedule formulas respectively indicating execution timing of the statements of FIG. 8.

S₁C₁i+c₁

S₂C₂i+c₂

S₃C₃i+c₃ (23)

The variable C₃ and the constant c₃ do not appear in the constraint equation because a data dependency does not exist in the statement S₃ as compared with the statements S₁ and S₂, and the statement S₃ may be executed at any timing. There are the infinite number of solutions each of which satisfies the variables C₁, C₂, and C₃. The compiler 120 typically selects a solution that has a small absolute value and does not correspond to a 0 vector. Therefore, the following solution is selected.

C₁=C₂=C₃=1 [symbol] c₁=c₂=c₃=0 (24)

Such a solution indicates optimization in which the coordinates for a value of “i” in FIG. 9 are assigned to an identical processor Pᵢ, and parallel execution without synchronization is performed.

In practice, since the execution of the statement S₃ does not depend on the statements S₁ and S₂, the following solution in which the statement S₃ is executed one iteration ahead for the statements S₁ and S₂ is also a correct solution.

C₁=C₂=C₃=1 [symbol] c₁=c₂=0 [symbol] c₃=−1 (25)

For the reason that the timing is to be shifted as described above, the improvement of data usage efficiency (improvement of cache usage efficiency), the improvement of data alignment status (promotion of SIMD), an increase in the number of threads in the case of parallel execution, and the like, are conceived. However, it is difficult for the user to easily select such a solution by the compiler 120 alone.

On the contrary, in the second embodiment, by using the optimization support unit 130, group selection of instances as illustrated in FIG. 9 may be performed.

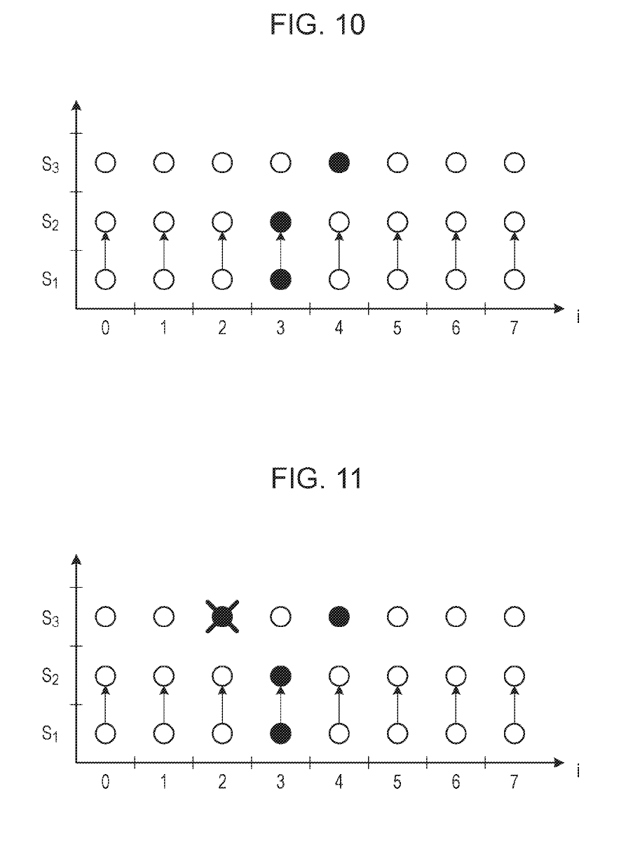

FIG. 10 is a diagram illustrating an example of a graph after the group selection has been performed. The coordinates (S, i) in the selected group are (S₁, 3), (S₂, 3), and (S₃, 4). Thus, the following new constraint set is obtained from such coordinate information G.

C₁3+c₁=g

C₂3+c₂=g

C₃4+c₃=g (26)

As a result, the following solution may be obtained by using a GUI.

C₁=C₂=C₃=1 [symbol] c₁=c₂=0 [symbol] c₃=−1 (27)

There is a case in which the grouped instances are not executed by an identical processor. In such a case, the optimization support unit 130 may perform error display.

<<Error Display Example of Grouping>>

Processing in which error detection and error display are achieved is described below in detail.

FIG. 11 is a diagram illustrating a first example of error display of grouping. For example, the following constraint equation calculated by the compiler when the optimization in which parallelism without synchronization is extracted is performed is obtained from the program 51 illustrated in FIG. 8.

C₁=C₂ [symbol] c₁=c₂ (28)

When the user performs group selection on the instances illustrated by the black circles illustrated in FIG. 11, the following new constraint set is obtained from the coordinate information G of these instances.

C₁3+c₁=g

C₂3+c₂=g

C₃2+c₃=g

C₃4+c₃=g (29)

In order to satisfy the following two constraint equations at the same time, “C₃=0” is required.

C₃2+c₃=g [symbol] C₃4+c₃=g (30)

However, here, when “C₃” is 0 in the following schedule formula indicating execution timing of the statement, the statement S₃ is arranged in a processor identified by the constant c₃ regardless of the variable i, which obtains a solution in which parallelism does not exist.

S₃C₃i+C₃ (31)

In order to avoid such an error, one of the following two constraints need to be removed.

C₃2+c₃=g

C₃4+c₃=g (32)

Here, the upper constraint of the formula (32) is obtained as a result of selection of the coordinates (S₃, 2) in FIG. 11, and the bottom constraint of the formula (32) is obtained as a result of selection of the coordinates (S₃, 4). In the example of FIG. 11, “x” mark is displayed on the black circle of the coordinates (S₃, 2) by regarding the selection that indicates the upper formula (32) as an error.

When a new constraint set that has been obtained from the coordinate information G of the result of the group selection becomes an error, typically, the error may be removed by removing some constraints from the new constraint set. However, there is a case in which the error is not solved unless the majority of the constraints is removed.

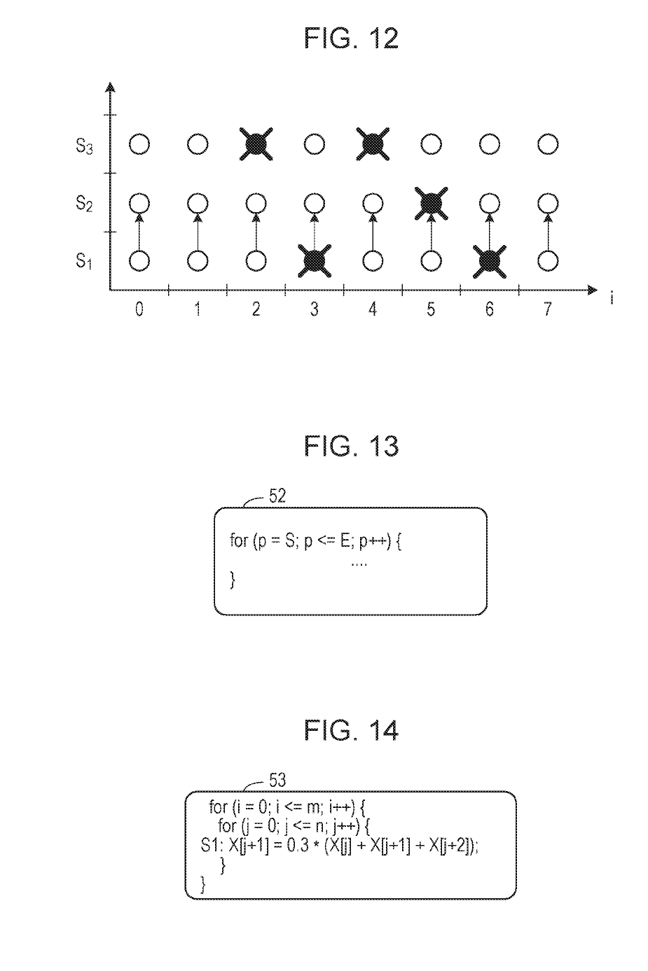

FIG. 12 is a diagram illustrating a second example of error display of grouping. For example, a case is conceived in which the user performs group selection illustrated by the black circles illustrated in FIG. 12. The following new constraint set is obtained from the coordinate information G.

C₁3+c₁=g

C₁6+c₁=g

C₂5+c₂=g

C₃2+c₃=g

C₃4+c₃=g (33)

In this case, a merely pair of one of the following formulas

C₁3+c₁=g

C₁6+c₁=g

C₂5+c₂=g (34)

and one of the following formulas is a solution allowed to be selected without setting C₁, C₂, C₃, and C₄ at 0.

C₃2+C₃=g

C₃4+c₃=g (35)

For example, when the following pair of formulas is selected, and the remaining constraints are removed as errors, a solution in which not all of C₁, C₂, C₃, and C₄ are set at 0 is allowed to be selected.

C₁3+c₁=₉

C₃2+c₃=g (36)

However, in this case, the majority of the selection that has been specified by the user are removed, so that it is not conceived that the result matches the request of the user. Thus, in such a case, the whole selection is regarded as an error, and “x” marks are displayed on all of the black circles as illustrated in FIG. 12.

<<Calculation of Evaluation Values for Grouping>>

When there is no error in the grouping as illustrated in FIG. 10, or when an error is removed by ignoring a part of the selection as illustrated in FIG. 11, evaluation values for the appropriateness of the grouping in the state in which there is no error are calculated. In the second embodiment, such evaluation values for the grouping correspond to, for example, data usage efficiency (cache usage efficiency), data alignment status, and the number of threads when the parallel execution is performed. Selection of an optimization method that is difficult to be achieved by a compiler alone is performed easily by respectively displaying these values on the evaluation value display sections 42 to 44 of the screen 40 illustrated in FIG. 5.

Examples of evaluation values of the grouping displayed on the screen illustrated in FIG. 5 and a calculation method of the evaluation values are described below. These evaluation values are not absolute evaluation values for performance improvement of a target program, but are values that are important hints for adjusting a result by the user.

<<<Data Usage Efficiency (Cache Usage Efficiency)>>>

In a case of accesses to array components, it is highly probable that instances are on an identical cache line when the instances exist within a certain distance on a memory. For example, in a program using a C language, it is highly probable that data of an array component A[X][Y][Z] and data of an array component A[X][Y][Z+1] are on an identical cache line. Thus, when instances of statements in grouping that has been selected by the user exist within a distance d (d is an integer of more than 0) on an identical array component, an evaluation value may be calculated by performing addition of one point (value of the distance is determined by a specification of a cache of a CPU in an execution environment). For example, a case is conceived in which instances of statements in the grouping access the following five array components.

A[3][5][0]

A[3][5][3]

A[3][5][6]

B[2][7]

B[2][10]

At this time, when “d=4” is satisfied, the following three sets are created.

(A[3][5][0], A[3][5][3])

(A[3][5][3], A[3][5][6])

(B[2][7], B[2][10])

In this case, an evaluation value “3” of the data usage efficiency is obtained. Such an evaluation value is displayed on the screen 40 illustrated in FIG. 5.

<<<Data Alignment Status>>>

An SIMD instruction of a CPU is, typically, an instruction to perform memory transfer of a power of two pieces of adjacent data at a time, and performs calculation for the pieces of data. Thus, in order to use the SIMD instruction of the CPU effectively, typically, it is desirable that the difference between the values of the addresses becomes a power of 2 when accesses to different arrays are performed. For example, it is probable that, in data of an array component A[0] and data of an array component B[2], the accesses may be performed as an array component A[i] and an array component B[i+2] using a loop variable i, which is mainly convenient in the case in which the SIMD instruction is used. On the contrary, it is probable that an SIMD instruction is not used for processing of the data of the array component A[0] and the data of an array component B[3].

Thus, in a case in which instances of statements in the grouping that has been selected by the user access different arrays, when the distance becomes a power of 2, an evaluation value may be calculated by performing addition of one point. For example, a case is conceived in which the instances of the statements in the grouping access the following five array components.

A[0]

A[3]

B[2]

B[8]

B[11]

At this time, the following three sets may be created.

(A[0], B[2], 2)

(A[0], B[8], 8)

(A[3], B[11], 8)

Thus, in this case, an evaluation value “3” of the data alignment status is obtained. Such an evaluation value is displayed on the screen 40 illustrated in FIG. 5.

<<<Number of Threads when Parallel Execution is >>

In the loop optimization method using the polyhedral model, the loop processing is optimized so that pieces of processing are allowed to be executed in parallel through a pipeline or the like.

FIG. 13 is a diagram illustrating an example of a program in which loop processing has been optimized. A program 52 corresponds to loop processing that has been optimized by a compiler, which is discussed, for example, in A. V. Aho, R. Sethi, J. D. Ullman, and M. S. Lam, “Compilers: Principles, Techniques, and Tools, Second Edition”, PEARSON Addison-Wesley, 2006.

Parallel execution may be performed on a loop illustrated in the program 52, and a variable p corresponds to each parallel execution thread number. Thus, as a result of the grouping that has been selected by the user, the total number of threads may be calculated as “E-S+1” from the initial value S and the end value E of the variable p by generating a loop with the format illustrated in FIG. 13.

Typically, the initial value S and the end value E correspond to a formula including a parameter variable in the program. That is, as the number of threads when the parallel execution is performed, the calculation result of the formula “E−S+1” is displayed on the screen 40 illustrated in FIG. 5. A hint of selection of a solution may be given to the user by displaying the number of threads when the parallel execution is performed.

<Loop Optimization Example 2>

A second example of loop optimization is described below.

FIG. 14 is a diagram illustrating a second example of a program including loop processing. As an example, a case is conceived in which a program 53 illustrated in FIG. 14 is optimized. In the program 53, a plurality of loop variables exists. In this case, for example, data dependency may be represented by a graph including an axis for each of the loop variables.

FIG. 15 is a diagram illustrating an example of a graph of a data dependency when a plurality of loop variables exists. In the program 53 illustrated in FIG. 14, merely a single statement S₁ (referred to as S1 in the program 53) exists. Therefore, when the graph illustrated in FIG. 15 is generated, the display is performed by respectively using loop variables i and j as the vertical axis and the horizontal axis without assignment of an axis to the type of a statement.

The following constraint equation calculated by the compiler when optimization in which parallelism with synchronization is extracted is performed is obtained from the program 53 illustrated in FIG. 14.

C₁≧0 [symbol] C₂≧0 [symbol] C₁−C₂≧0 (37)

Here, the variables C₁ and C₂ are variables of the following schedule formula indicating execution timing of the statement illustrated in FIG. 14.

C₁i+C₂j+c (38)

There is the infinite number of solutions each of which satisfies the variables C₁ and C₂. Typically, the compiler 120 selects a solution that has a small absolute value and that does not correspond to a 0 vector. Therefore, the following solution is selected.

C₁=1 [symbol] C₂=0 (39)

Alternatively, the following solution is selected.

C₁=1 [symbol] C₂=1 (40)

When the solution of the formula (39) is selected, the iteration space illustrated in FIG. 16 is obtained.

FIG. 16 is a diagram illustrating a first example of an iteration space of loop processing. In this case, optimization is indicated in which the coordinates of a value j in FIG. 16 are assigned to an identical processor Pj, and parallel execution with synchronization is performed.

When the second solution is selected, the iteration space illustrated in FIG. 17 is obtained as a result of selection.

FIG. 17 is a diagram illustrating a second example of an iteration space of loop processing. In this case, optimization is indicated in which the coordinates of a value i in FIG. 17 are assigned to an identical processor Pi, and parallel execution with synchronization is performed. It is difficult for the user to easily select such a solution by the compiler 120 alone. In addition, it is difficult for the user to easily know the iteration spaces obtained from the two solutions.

On the contrary, in the second embodiment, by using the optimization support unit 130, for the data dependency illustrated in FIG. 15, instances to be grouped by using a GUI may be selected.

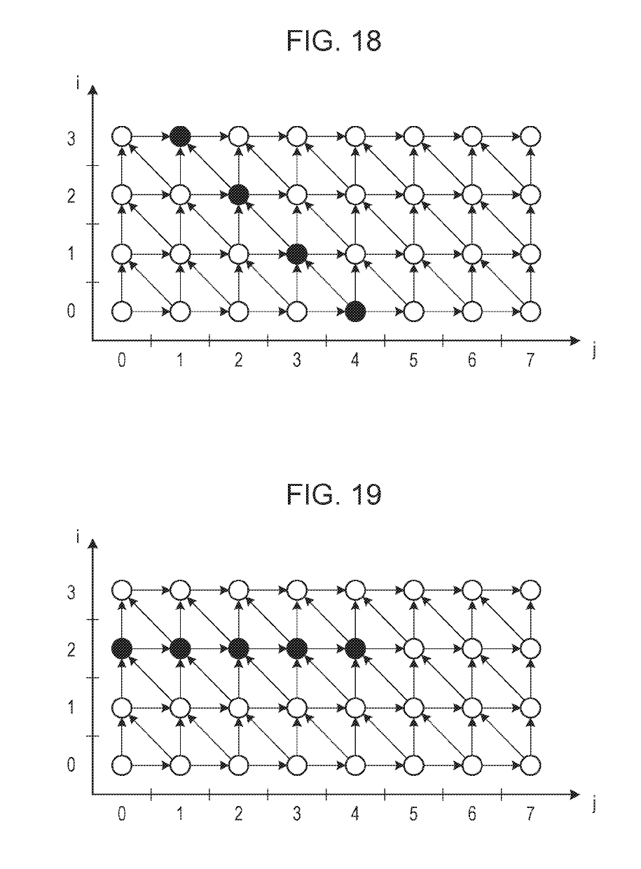

FIG. 18 is a diagram illustrating a first selection example of instances to be grouped. The coordinates (S, j, i) in the selected group correspond to (S₁, 1, 3), (S₁, 2, 2), (S₁, 3, 1), and (S₁, 4, 0). Thus, the following new constraint set is obtained from the coordinate information G.

C₁3+C₂1=g

C₁2+C₂2=g

C₁1+C₂3=g

C₁0+C₂4=g (41)

In such a new constraint set, the following formula corresponds to a solution.

C₁=1 [symbol] C₂=1 (42)

However, the following formula does not correspond to a solution.

C₁=1 [symbol] C₂=0 (43)

Thus, by using the GUI, a solution that corresponds to the iteration space illustrated in FIG. 17 may be selected.

In addition, for the data dependency illustrated in FIG. 15, another group selection also may be performed.

FIG. 19 is a diagram illustrating a second selection example of instances to be grouped. For example, when a group is selected as illustrated in FIG. 19, coordinates (S, j, i) in the selected group correspond to (S1, 0, 2), (S1, 1, 2), (S1, 2, 2), (S1, 3, 2), and (S1, 4, 2). Thus, the following new constraint set is obtained from the coordinate information G.

C₁2+C₂0=g

C₁2+C₂1=g

C₁2+C₂2=g

C₁2+C₂3=g

C₁2+C₂4=g (44)

In such a new constraint set, the following formula corresponds to a solution.

C₁=1 [symbol] C₂=0 (45)

However, the following formula does not correspond to a solution.

C₁=1 [symbol] C₂=1 (46)

Thus, by using the GUI, a solution that corresponds to the iteration space illustrated in FIG. 16 may be selected.

It is not necessarily the case that there exists a solution for the group that has been selected by the user. For example, it is assumed that (S₁, 1, 3), (S₁, 2, 2), (S₁, 3, 1), (S₁, 4, 0), and (S₁, 5, 0) are selected as the coordinates (S, j, i), for the data dependency illustrated in FIG. 15. The following set constraint set is obtained from the coordinate information G.

C₁3+C₂1=g

C₁2+C₂2=g

C₁1+C₂3=g

C₁0+C₂4=g

C₁0+C₂5=g (47)

In such a new constraint set, the following formula does not correspond to a solution.

C₁=1 [symbol] C₂=0 (48)

In addition, the following formula also does not correspond to a solution, so that a solution does not exist.

C₁=1 [symbol] C₂=1 (49)

In such a case, in the second embodiment, the optimization support unit 130 creates all subsets in a set of the coordinate information, and calculates whether a solution exists for each of the subsets. In addition, the optimization support unit 130 employs a subset in which a solution exists and that has the largest number of constraints, and the optimization support unit 130 reports to the user that there is a problem in a constraint that is not included in the subset. For example, in this case, as long as merely a constraint of the following formula is removed,

C₁0+C₂5=g (50)

a solution of the following formula exists.

C₁=1 [symbol] C₂=1 (51)

Therefore, the optimization support unit 130 employs the solution of the formula (51), and reports to the user that there is a problem in the coordinate (S₁, 5, 0).

The following cases may be dealt with by reporting the situation to the user even when there is a problem in the selected group as described above, and advancing the optimization.

The optimization may be advanced as much as possible even when the user does not fully imagine a correct transformation result.

In addition, there is a case in which the visibility of the instances when the iteration space of the loop has been displayed by the GUI is poor. For example, when the iteration space is displayed in a three dimension, the figures indicating the instances (for example, the circles) are displayed so as to be close to each other, or a figure in which there is a problem is obscured by a figure that has been displayed in front of the figure. Even in such a case, the optimization may be advanced.

As described above, in the second embodiment, the optimization that is difficult to be selected by a compiler alone may be achieved. In addition, the optimization that is difficult to be specified by a text-based tool may be instructed by using the GUI. In addition, even when an input from the user through the GUI is not accurate, the possibility of the optimization may be expanded by selecting an executable solution that is close to the request of the user.

As describe above, the embodiments are described, but the configuration of each of the units illustrated in the embodiments may be replaced with another configuration having a similar function. In addition, any other configuration object or process may be added to the configuration of each of the units illustrated in the embodiments. In addition, configurations (characters) of certain two or more embodiments may be combined from among the above-described embodiments.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory, computer-readable recording medium having stored therein a program for causing a computer to execute a process comprising:
based on a description of loop processing included in a source code, for each of count values each indicating a number of times the loop processing has been iterated, displaying instructions of one loop portion corresponding to the each count value by arranging the instructions in predetermined order;
displaying a dependence relationship between a pair of instructions having a data dependence;
upon receiving a first input to specify that an instruction group including a plurality of instructions having no dependences on each other is executed by an identical processor, calculating a first evaluation value indicating usage efficiency of a cache memory, a second evaluation value indicating an alignment degree of used data, and a third evaluation value indicating a number of threads at a time of parallel execution;
displaying the calculated first evaluation value, second evaluation value, and third evaluation value; and
upon receiving a second input to determine the instruction group, compiling the source code, and performing, on the loop processing, loop optimization using a polyhedral model under constraints in which the instruction group is executed by the identical processor.

2. The non-transitory, computer-readable recording medium of claim 1, the process further comprising:
in response to the first input, evaluating a validity of the first input, based on whether the plurality of instructions included in the instruction group are executable by the identical processor; and
displaying a result of the evaluating.

3. The non-transitory, computer-readable recording medium of claim 2, wherein
in the evaluating the validity of the first input, an instruction not included in a subset in the instruction group is identified when not all of the plurality of instructions included in the instruction group are executable by the identical processor but instructions constituting the subset are executable by the identical processor; and
in the displaying the result of the evaluation, error display is performed on the identified instruction.

4. The non-transitory, computer-readable recording medium of claim 1, wherein
in the performing the loop optimization, when not all of the plurality of instructions in the instruction group are executable by the identical processor but instructions constituting the subset is executable by the identical processor, the loop optimization using the polyhedral model is performed for the loop processing under a constraint in which the instructions constituting the subset is executed by the identical processor.

5. The non-transitory, computer-readable recording medium of claim 1, wherein
as data array used for processing executed by the identical processor is easier to be processed by a single instruction multiple data (SIMD) instruction, the second evaluation value is calculated as a higher value.

6. A method for optimizing loop processing under constraint on processors to be used, the method comprising:
based on a description of loop processing included in a source code, for each of count values each indicating a number of times the loop processing has been iterated, displaying instructions of one loop portion corresponding to the each count value by arranging the instructions in predetermined order;
displaying a dependence relationship between a pair of instructions having a data dependence;
upon receiving an input to specify that an instruction group including a plurality of instructions having no dependences on each other is executed by an identical processor, calculating a first evaluation value indicating usage efficiency of a cache memory, a second evaluation value indicating an alignment degree of used data, and a third evaluation value indicating a number of threads at a time of parallel execution;
displaying the calculated first evaluation value, second evaluation value, and third evaluation value; and
upon receiving an input to determine the instruction group, compiling the source code, and performing, on the loop processing, loop optimization using a polyhedral model under constraints in which the instruction group is executed by the identical processor.
